(19) United States
(12) Patent Application Publication
(10) Pub. No.: US 2026/0179553 A1
(43) Pub. Date: Jun. 25, 2026

(54) LIGHT EMITTING DISPLAY APPARATUS

(71) Applicant: LG Display Co., Ltd., Seoul (KR)

(72) Inventors: Sang-Soo LEE, Paju-si (KR); Seon-Geun GIM, Paju-si (KR)

(73) Assignee: LG Display Co., Ltd., Seoul (KR)

(21) Appl. No.: 19/403,517

(22) Filed: Nov. 28, 2025

(30) Foreign Application Priority Data
Dec. 24, 2024 (KR) 10-2024-0194959

(51) Int. Cl. G09G 3/3233; G09G 3/20

(52) U.S. Cl. CPC G09G 3/3233; G09G 3/2096; G09G 2300/0819; G09G 2300/0852; G09G 2300/0861; G09G 2320/045; G09G 2330/021; G09G 2330/06

(57) ABSTRACT

A light emitting display apparatus includes a display panel having pixels arranged therein and each of the pixels including a light emitting diode, a timing control portion including a degradation data calculation portion configured to calculate degradation data representing a degradation amount of the pixel based on input image data, and a first serial peripheral interface (SPI) communication portion configured to transmit and receive the degradation data through an SPI communication, a memory including a second SPI communication portion configured to perform the SPI communication with the first SPI communication portion, and storing the degradation data, and a driving power selection portion configured to selectively provide a first driving power and a second driving power lower than the first driving power to the first SPI communication portion. When the SPI communication is on, the second driving power is provided to the first SPI communication portion.

### CROSS-REFERENCE TO RELATED APPLICATIONS

The present application claims priority to Korean Patent Application No. 10-2024-0194959, filed in Republic of Korea on Dec. 24, 2024, which is hereby incorporated by reference in its entirety for all purposes as if fully set forth herein.

### BACKGROUND

### Field of the Invention

The present disclosure relates to an apparatus and particularly to, for example, without limitation, a light emitting display apparatus.

### Discussion of the Related Art

As the information society develops, a demand for display apparatuses for displaying images has increased in various forms. In recent years, various flat display apparatuses such as organic light emitting display apparatuses and liquid crystal display apparatuses have been used.

The description provided in the discussion of the related art section should not be assumed to be prior art merely because it is mentioned in or associated with that section. The discussion of the related art section can include information that describes one or more aspects of the subject technology, and the description in this section does not limit the disclosure.

### SUMMARY OF THE DISCLOSURE

A light emitting display apparatus degrades over time. To compensate for this, a timing control portion accumulates a degradation amount and transmits it to a memory, and the timing control portion receives the degradation amount stored in the memory and compensates for image data based on the degradation amount.

A serial peripheral interface (SPI) communication is used between the timing control portion and the memory to transmit degradation amount data. However, a clock signal used to synchronize an SPI communication frequency can overshoot and undershoot.

The overshoot and undershoot can increase an energy of the SPI communication frequency, thereby exceeding required EMI specifications.

An advantage of the present disclosure is to provide a display apparatus that can reduce an increase in energy of frequency due to overshoot and undershoot in SPI communications.

Another advantage of the present disclosure is to provide a display apparatus that can address the limitations and disadvantages associated with the related art.

Additional features and advantages of the disclosure will be set forth in the description which follows, and in part will be apparent from the description, or can be learned by practice of the disclosure. These and other advantages of the disclosure will be realized and attained by the structure particularly pointed out in the written description and claims hereof as well as the appended drawings.

To achieve these and other advantages and in accordance with the purpose of the present disclosure, as embodied and broadly described herein, a light emitting display apparatus includes a display panel including pixels arranged therein, each of the pixels including a light emitting diode; a timing control portion including a degradation data calculation portion configured to calculate degradation data representing degradation amount of the pixel based on input image data, and a first SPI communication portion configured to transmit and receive the degradation data through an SPI communication; a memory including a second SPI communication portion configured to perform the SPI communication with the first SPI communication portion, and storing the degradation data; and a driving power selection portion configured to selectively provide a first driving power and a second driving power lower than the first driving power to the first SPI communication portion, wherein when the SPI communication is on, the second driving power is provided to the first SPI communication portion.

In another aspect of the present disclosure, a light emitting display apparatus includes a display panel including pixels arranged therein, each of the pixel including a light emitting diode; a timing control portion including a degradation data calculation portion configured to calculate degradation data of the pixel based on input image data; a memory configured to transmit and receive the degradation data through an SPI communication with the timing control portion; and a driving power selection portion configured to adjust a driving power of the timing control portion, wherein the driving power selection portion is configured to adjust the driving power to be lowered when the SPI communication is on.

It is to be understood that both the foregoing general description and the following detailed description are examples and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 is a view schematically illustrating a light emitting display apparatus according to one or more embodiments of the present disclosure;

FIG. 2 is a circuit view schematically illustrating an example of a pixel according to an embodiment of the present disclosure;

FIG. 3 is a view illustrating a configuration of a gate driving portion of a light emitting display apparatus according to an embodiment of the present disclosure;

FIG. 4 is a cross-sectional view schematically illustrating an example of a cross-sectional structure of a display panel according to an embodiment of the present disclosure;

FIG. 5 is a view schematically illustrating configuration of a timing control portion and a memory according to an embodiment of the present disclosure;

FIG. 6 is a view schematically illustrating a driving power selection portion provided in a timing control portion according to an embodiment of the present disclosure;

FIG. 7 is a view schematically illustrating an example of a waveform of a clock signal generated using a normal driving power in an SPI communication according to a comparative example;

FIG. 8 is a view schematically illustrating an example of a waveform of a clock signal generated using a low driving power in an SPI communication according to an embodiment of the present disclosure; and

FIG. 9 is a view illustrating simulation results for clock signals generated using a low driving power in an SPI communication according to an embodiment of the present disclosure.

### DETAILED DESCRIPTION OF THE EMBODIMENTS

Advantages and features of the present disclosure and methods of achieving them will be apparent with reference to the embodiments described below in detail with the accompanying drawings. However, the present disclosure is not limited to the embodiments disclosed below, but can be realized in a variety of different forms, and these embodiments allow the present disclosure to be complete. The present disclosure is provided to fully inform the scope of the disclosure to the skilled in the art of the present disclosure, and the present disclosure can be defined by the scope of the claims.

The shapes, sizes, proportions, angles, numbers, and the like disclosed in the drawings for explaining the embodiments of the present disclosure are illustrative, and the present disclosure is not limited to the illustrated matters. The same reference numerals refer to the same components throughout the description.

Furthermore, in describing the present disclosure, if it is determined that a detailed description of the related known technology unnecessarily obscure the subject matter of the present disclosure, the detailed description thereof can be omitted. When ‘comprising’, ‘including’, ‘having’, ‘consisting’, and the like are used in this disclosure, other parts can be added unless ‘only’ is used. When a component is expressed in the singular, cases including the plural are included unless specific statement is described.

In interpreting the components, even if there is no separate explicit description, it is interpreted as including a margin range.

In the case of a description of a positional relationship, for example, when the positional relationship of two parts is described using terms such as ‘on’, ‘over’, ‘above’, ‘below’, ‘beside’, ‘under’, and the like, one or more other parts can be positioned between such two parts unless ‘right’ or ‘directly’ is used.

In the case of a description of a temporal relationship, for example, when a temporal precedence is described as ‘after’, ‘following’, ‘before’, and the like, cases that are not continuous can be included unless ‘directly’ or ‘immediately’ is used.

In describing components of the present disclosure, terms such as first, second and the like can be used. These terms are only for distinguishing the components from other components, and an essence, order, sequence, or number of the components is not limited by the terms. Further, the term “can” fully encompasses all the meanings and coverages of the term “may” and vice versa.

Respective features of various embodiments of the present disclosure can be partially or wholly connected to or combined with each other and can be technically interlocked and driven variously, and respective embodiments can be independently implemented from each other or can be implemented together with a related relationship.

Any implementation described herein as an “example” is not necessarily to be construed as preferred or advantageous over other implementations.

Further, when an element or layer is “connected,” “coupled,” or “adhered” to another element or layer denotes that the element or layer can not only be directly connected or adhered to the other element or layer, but also be indirectly connected or adhered to the other element or layer with one or more intervening elements or layers “disposed,” or “interposed” between the elements or layers, unless otherwise specified. It should be understood to mean that elements can be so disposed to directly contact each other, or can be so disposed without directly contacting each other.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning, for example consistent with their meaning in the context of the relevant art and should not be interpreted in an idealized or overly formal sense unless expressly so defined herein. For example, the term “part” or “unit” can apply, for example, to a separate circuit or structure, an integrated circuit, a computational block of a circuit device, or any structure configured to perform a described function as should be understood to one of ordinary skill in the art.

Hereinafter, embodiments of the present disclosure are described in detail with reference to the drawings. All the components of each display apparatus/device according to all embodiments of the present disclosure are operatively coupled and configured. Meanwhile, in the following embodiments, the same and like reference numerals are assigned to the same and like components, and detailed descriptions thereof can be omitted.

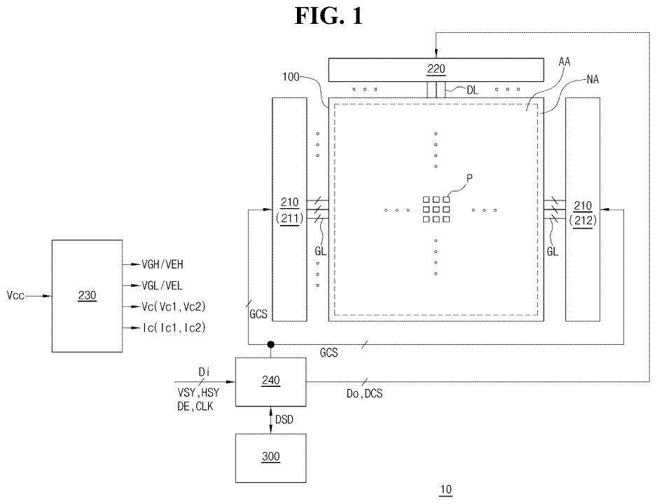

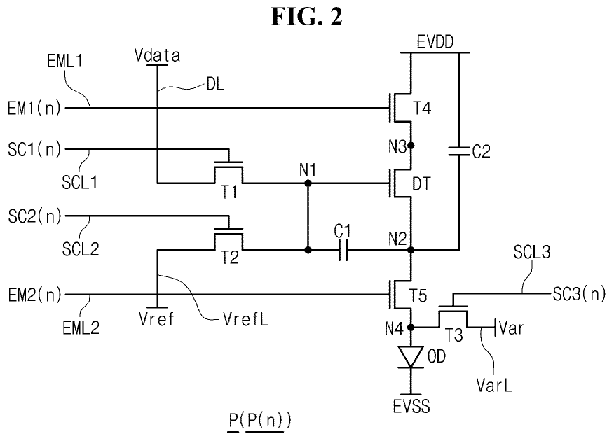

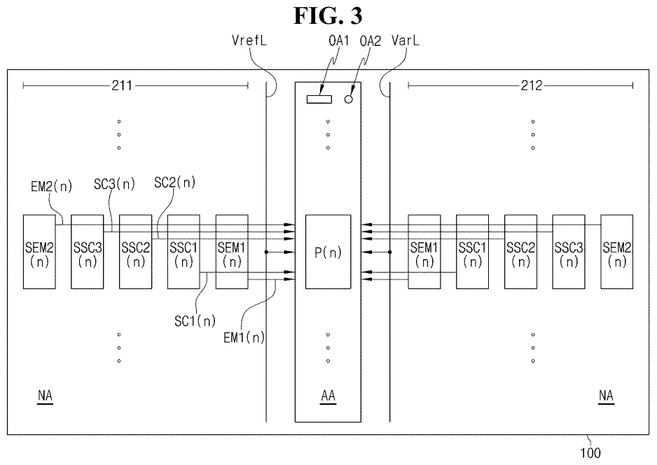

FIG. 1 is a view schematically illustrating a light emitting display apparatus according to one or more embodiments of the present disclosure. FIG. 2 is a circuit view schematically illustrating an example of a pixel according to an embodiment of the present disclosure. FIG. 3 is a view illustrating a configuration of a gate driving portion of a light emitting display apparatus according to an embodiment of the present disclosure.

Prior to a specific description, an organic light emitting display apparatus is described as an example of the light emitting display apparatus 10.

Referring to FIGS. 1 to 3, the light emitting display apparatus 10 of this embodiment can include a display panel 100 and a driving circuit portion that drives the display panel 100.

Here, the driving circuit portion can include, for example, a gate driving portion (or gate driving circuit) 210, a data driving portion (or data driving circuit) 220, and a timing control portion (or timing control circuit) 240. In addition, the driving circuit portion can include a power supply portion (or power supply circuit) 230 that supplies power required for driving the display panel 100, the gate driving portion 210, the data driving portion 220, and the timing control portion 240.

Moreover, the light emitting display apparatus 10 of this embodiment can include a memory 300 that stores a degradation amount accumulated in the display panel 100.

The display panel 100 can include a display region AA (or active area) that displays an image, and a non-display region NA (or non-display area) arranged outside the display region AA (or surrounding the display region AA).

In the display region AA, a plurality of pixels P can be arranged in a matrix form along a plurality of horizontal lines (or row lines) and a plurality of vertical lines (or column lines).

Here, the plurality of pixels P can include pixels that display different colors, for example, red, green, and blue pixels that display red, green, and blue, respectively, but not limited thereto.

In the display panel 100, various signal lines that transmit driving signals for driving the pixels P can be formed on a substrate.

In this regard, for example, a plurality of data lines DL that transmit data signals (or data voltages) which are image signals can extend in the vertical direction and be connected to the pixels P of the respective vertical lines.

In addition, a gate line GL that transmits a gate signal (or gate voltage) can extend in the horizontal direction and be connected to the pixel P of the corresponding horizontal line.

In this embodiment, a plurality of gate signals can be used to drive each pixel P, for example, a first scan signal SC1 to a third scan signal SC3, a first emission control signal EM1, and a second emission control signal EM2 can be used. Accordingly, a plurality of gate lines GL respectively transmitting the plurality of gate signals can be used, for example, a first scan line SCL1 to a third scan line SCL3, a first emission control line EML1, and a second emission control line EML2 can be used.

As such, the plurality of pixels P can be defined by the plurality of data lines DL and gate lines GL intersecting each other.

Each pixel P can include a light emitting diode OD as a light emitting element, and a plurality of transistors and at least one capacitor for driving the light emitting diode OD.

Meanwhile, in this embodiment, for convenience of explanation, a 6T2C structure in which the pixel P is equipped with six transistors T1 to T5 and DT and two capacitors C1 and C2 as illustrated in FIG. 2 is taken as an example. Each pixel P in the display apparatus in FIG. 1 or any other figures can have the pixel configuration of FIG. 2.

Referring to FIG. 2, the pixel P can include a plurality of switching transistors, for example, first transistor T1 to fifth transistor T5, a driving transistor DT, a first capacitor C1, a second capacitor C2, and the light emitting diode OD.

Each of the first to fifth transistors T1 to T5 and the driving transistor DT can include a first electrode, a second electrode, and a gate electrode. One of the first electrode and the second electrode can be a source electrode, and the other of the first electrode and the second electrode can be a drain electrode.

Each of the first to fifth transistors T1 to T5 and the driving transistor DT can be a P-type or N-type transistor. Meanwhile, in FIG. 2, an example is given in which the first to fifth transistors T1 to T5 are configured as N-type transistors, and the driving transistor DT is configured as a N-type transistor, but not limited thereto.

The first transistor T1 to the fifth transistor T5 and the driving transistor DT can include semiconductors of the same material or can include semiconductors of different materials. In this regard, for example, some of the first transistor T1 to the fifth transistor T5 and the driving transistors DT can have one semiconductor layer among a polycrystalline silicon layer, an oxide semiconductor layer, and an amorphous silicon layer, and another some of the first transistor T1 to the fifth transistor T5 and the driving transistors DT can have another semiconductor layer among a polycrystalline silicon layer, an oxide semiconductor layer, and an amorphous silicon layer.

An oxide semiconductor has excellent off-current characteristics, and a polycrystalline silicon has excellent mobility. In this embodiment, an example is given in which the driving transistor DT can have an oxide semiconductor layer, and each of the first transistor T1 to the fifth transistor T5 can have an oxide semiconductor layer or a polycrystalline silicon layer, but not limited thereto.

The gate signals provided to a n-th horizontal line of FIG. 2 can be provided from a corresponding n-th stage of the gate driving portion 210. For example, three scan signals, first to third scan signals (SC1 to SC3: SC1(n) to SC3(n)) and two emission control signals, first and second emission control signals (EM1 and EM2: EM1(n) and EM2(n)) can be provided. In this case, in the display region AA, first to third scan lines SCL1 to SCL3 and first and second emission control lines EML1 and EML2 that are connected to the n-th stage and transmit the first to third scan signals SC1(n) to SC3(n) and the first and second emission control signals EM1(n) and EM2(n) to the pixel P can be arranged. Here, n can be a real number such as a positive integer.

The first transistor T1 can function as a data supply transistor, the second transistor T2 can function as an initialization transistor, the third transistor T3 can function as a reset transistor, the fourth and fifth transistors T4 and T5 can function as emission control transistors.

The light emitting diode OD can include an anode electrode and a cathode electrode. The anode electrode of the light emitting diode OD can be connected to a fourth node N4, and the cathode electrode of the light emitting diode OD can be applied with a low-potential driving voltage EVSS.

The driving transistor DT can include, for example, a first electrode connected to a second node N2, a second electrode connected to a third node N3, and a gate electrode connected to a first node N1. The driving transistor DT can provide a driving current (or emission current) to the light emitting diode OD based on a voltage of the first node N1 (i.e., a voltage stored in the first capacitor C1).

The first transistor T1 can include a second electrode connected to the data line DL (or receiving the data voltage Vdata), a first electrode connected to the first node N1, and a gate electrode receiving the first scan signal SC1(n). The first transistor T1 can be turned on in response to the first scan signal SC1(n) and can transmit the data voltage Vdata to the first node N1. In this case, the data voltage Vdata can be applied to the gate electrode of the driving transistor DT.

The first capacitor C1 can function as a compensation capacitor. The first capacitor C1 can be connected between the first node N1 and the second node N2. The first capacitor C1 can store and maintain a voltage applied to the gate electrode of the driving transistor DT. Furthermore, a threshold voltage (Vth) of the driving transistor DT can be sampled in the first capacitor C1.

The second transistor T2 can include a second electrode connected to a reference voltage line VrefL that transmits a reference voltage Vref, a first electrode connected to the first node N1, and a gate electrode that receives the second scan signal SC2(n). The second transistor T2 can be turned on in response to the second scan signal SC2(n) and transmit the reference voltage Vref to the first node N1. Accordingly, the gate electrode of the driving transistor DT can be initialized by the reference voltage Vref.

The third transistor T3 can include a second electrode connected to a reset voltage line VarL that transmits a reset voltage (or anode reset voltage) Var, a first electrode connected to the fourth node N4, and a gate electrode that receives the third scan signal SC3(n). The third transistor T3 can be turned on in response to the third scan signal SC3(n) and transmit the reset voltage Var to the fourth node N4. Accordingly, the anode electrode of the light emitting diode OD can be reset by the reset voltage Var.

The fourth transistor T4 can include a second electrode connected to a line that transmits a high-potential driving voltage EVDD, a first electrode connected to the third node N3, and a gate electrode that receives the first emission control signal EM1(n).

The fifth transistor T5 can include a second electrode connected to the second node N2, a first electrode connected to the fourth node N4 (or the anode electrode of the light emitting diode OD), and a gate electrode receiving the second emission control signal EM2(n).

The fourth and fifth transistors T4 and T5 can be turned on in response to the first and second emission control signals EM1(n) and EM2(n), a driving current can be supplied to the light emitting diode OD, and the light emitting diode OD can emit light at a brightness corresponding to the driving current.

The second capacitor C2 can function as an auxiliary capacitor. The second capacitor C2 can be connected between the line transmitting the high-potential driving voltage EVDD and the second node N2.

As described above, the pixel driving circuit driving the pixel P can use a source follower type compensation circuit to compensate for the threshold voltage (Vth) of the driving transistor DT.

When driving the display panel 100 including the pixel P configured as described above, for example, an initialization period (or reset period), a sampling period, a data writing period, and an emission period can be sequentially set for each frame.

In the initialization period, for example, the second and third scan signals SC2(n) and SC3(n) having turn-on levels can be applied to the second and third transistors T2 and T3, so that the second and third transistors T2 and T3 can be turned on, the reference voltage Vref can be provided to the first node N1, and the reset voltage Var can be transmitted to the fourth node N4. Meanwhile, in the initialization period, the first scan signal SC1(n) can have a turn-off level and the first transistor T1 can be turned off, the first emission control signal EM1(n) can have a turn-off level and the fourth transistor T4 can be turned off, and the second emission control signal EM2(n) can have a turn-on level and the fifth transistor T5 can be turned on.

In the sampling period after the initialization period, for example, the second scan signal SC2(n) having a turn-on level can be applied to the second transistor T2 and the second transistor T2 can be turned on, and the reference voltage Vref can be provided to the first node N1. In addition, the first and second emission control signals EM1(n) and EM2(n) having turn-on levels can be applied to the fourth and fifth transistors T4 and T5, so that the fourth and fifth transistors T4 and T5 can be turned on. Accordingly, the threshold voltage (Vth) of the driving transistor DT can be sampled and stored in the first capacitor C1. Meanwhile, in the sampling period, the first scan signal SC1(n) can have a turn-off level to turn off the first transistor T1, and the third scan signal SC3(n) can have a turn-off level to turn off the third transistor T3.

In the data writing period after the sampling period, for example, the first scan signal SC1(n) having a turn-on level can be applied to the first transistor T1, so that the first transistor T1 can be turned on, and the data voltage Vdata can be provided to the first node N1 and be applied to the gate electrode of the driving transistor DT. Meanwhile, in the data writing period, the second scan signal SC2(n) can have a turn-off level to turn off the second transistor T2, the third scan signal SC3(n) can have a turn-off level to turn off the third transistor T3, the first emission control signal EM1(n) can have a turn-off level to turn off the fourth transistor T4, and the second emission control signal EM2(n) can have a turn-off level to turn off the fifth transistor T5.

In the emission period after the data writing period, for example, the first and second emission control signals EM1(n) and EM2(n) having turn-on levels can be applied to the fourth and fifth transistors T4 and T5, so that the fourth and fifth transistors T4 and T5 can be turned on. Accordingly, a driving current corresponding to the data voltage Vdata can be generated through the driving transistor DT and provided to the light emitting diode OD, and the light emitting diode OD can emit light. Meanwhile, in the emission period, the first scan signal SC1(n) can have a turn-off level to turn off the first transistor T1, the second scan signal SC2(n) can have a turn-off level to turn off the second transistor T2, and the third scan signal SC3(n) can have a turn-off level to turn off the third transistor T3.

The 6T2C structure of the pixel P described above is an example, and the pixel P of this embodiment can be configured with a different structure.

Referring to FIG. 1, the timing control portion 240 can process input image data Di input from a host system to be suitable for size, resolution, etc. of the display panel 100 and supply processed output image data Do to the data driving portion 220. The timing control portion 240 can generate a gate control signal GCS and a data control signal DCS using synchronization signals input from the host system, for example, a dot clock signal CLK, a data enable signal DE, a horizontal synchronization signal HSY, and a vertical synchronization signal VSY. By supplying the gate control signal GCS and the data control signal DCS generated in this way to the gate driving portion 210 and the data driving portion 220, respectively, the gate driving portion 210 and the data driving portion 220 can be controlled.

The timing control portion 240 can be configured to be combined with various processors, for example, a microprocessor, a mobile processor, an application processor, etc., depending on a device to be mounted.

Meanwhile, the host system can be, for example, a driving system that drives an electronic device to which the light emitting display apparatus 10 is applied. The electronic device can be, for example, one of a TV (television), a navigation system, a monitor, a mobile device, and a wearable device.

The gate driving portion 210 can receive the gate control signal GCS from the timing control portion 240, generate the gate signals, and sequentially apply the gate signals to the gate lines GL. For example, the gate signals can be sequentially output from the top to the bottom in the vertical direction.

The gate driving portion 210 can be arranged, for example, on at least one side of the display region AA. In this embodiment, a case is taken as an example in which the gate driving portion 210 is configured to include first and second gate driving portions 211 and 212 arranged on both sides of the display region AA, for example, on the left and right sides of the display region AA.

The gate driving portion 210 can be formed directly in the non-display region NA on the substrate of the display panel 100, for example, in a GIP (gate-in panel) structure. In this case, the gate driving portion 210 can be formed during processes of forming elements of the display panel 100.

The gate driving portion 210 configured with the GIP structure can include, for example, a first scan driving circuit that sequentially outputs the first scan signals SC1, a second scan driving circuit that sequentially outputs the second scan signals SC2, a third scan driving circuit that sequentially outputs the third scan signals SC3, a first emission driving circuit that sequentially outputs the first emission control signals EM1, and a second emission driving circuit that sequentially outputs the second emission control signals EM2.

Each of the first scan driving circuit to the third scan driving circuit and the first and second emission driving circuits can be configured with a shift register including a plurality of stages that output respective signals.

The gate driving portion 210 is described with further reference to FIG. 3. FIG. 3 illustrates a part of the gate driving portion 210, and for convenience of explanation, a configuration of a portion of the gate driving portion 210 that drives the n-th horizontal line of the display region AA is illustrated.

In the first gate driving portion 211 of the gate driving portion 210, for example, first to third scan stages SSC1(n) to SSC3(n) that constitute the first to third scan driving circuits, respectively, and first and second emission stages SEM1(n) and SEM2(n) that constitute the first and second emission driving circuits, respectively, can be arranged. Here, n can be a real number such as a positive integer.

In addition, in the second gate driving portion 212 of the gate driving portion 210, for example, the first to third scan stages SSC1(n) to SSC3(n) that constitute the first to third scan driving circuits, respectively, and the first and second emission stages SEM1(n) and SEM2(n) that constitute the first and second emission driving circuits, respectively, can be arranged.

The arrangement of the first to third scan stages SSC1(n) to SSC3(n) and the first and second emission stages SEM1(n) and SEM2(n) shown in FIG. 3 is an example, and they can be arranged in various combinations in the first and second gate driving portions 211 and 212.

The first scan stage SSC1(n) can generate the first scan signal SC1(n) and output it to the corresponding first scan line SCL1. Accordingly, the pixel P(n) of the n-th horizontal line can be applied with the first scan signal SC1(n).

The second scan stage SSC2(n) can generate the second scan signal SC2(n) and output it to the corresponding second scan line SCL2. Accordingly, the pixel P(n) of the n-th horizontal line can be applied with the second scan signal SC2(n).

The third scan stage SSC3(n) can generate the third scan signal SC3(n) and output it to the corresponding third scan line SCL3. Accordingly, the pixel P(n) of the n-th horizontal line can be applied with the third scan signal SC3(n).

The first emission stage SEM1(n) can generate the first emission control signal EM1(n) and output it to the corresponding first emission control line EML1. Accordingly, the pixel P(n) of the n-th horizontal line can be applied with the first emission control signal EM1(n).

The second emission stage SEM2(n) can generate the second emission control signal EM2(n) and output it to the corresponding second emission control line EML2. Accordingly, the pixel P(n) of the n-th horizontal line can be applied with the second emission control signal EM2(n).

Meanwhile, referring to FIG. 3, the reference voltage line VrefL and the reset voltage line VarL can be arranged between the gate driving portion 210 and the display region AA.

The reference voltage line VrefL and the reset voltage line VarL can respectively supply the reference voltage Vref and the reset voltage Var from the power supply portion 230 to the pixels P within the display region AA.

In FIG. 3, each of the reference voltage line VrefL and the reset voltage line VarL is illustrated as being located on the left or right side of the display region AA, but not limited thereto, and each of the reference voltage line VrefL and the reset voltage line VarL can be located on both sides, and even if located on one side, the location on the left or right side is not limited.

Furthermore, referring to FIG. 3, one or more optical regions OA1 and OA2 can be disposed in the display region AA.

The one or more optical regions OA1 and OA2 can be arranged to overlap one or more optical electronic devices, for example, a photographing device such as a camera (or image sensor), and/or a detection sensor such as a proximity sensor and an illuminance sensor. For the operation of the optical electronic device, the one or more optical regions OA1 and OA2 can have a light-transmitting structure formed therein and can have transmittance of a certain level or higher. In other words, a number of pixels P per unit area in the one or more optical regions OA1 and OA2 can be smaller than a number of pixels P per unit area in a regular region excluding the optical regions OA1 and OA2 in the display region AA. For example, a resolution of the one or more optical regions OA1 and OA2 can be lower than a resolution of the regular region within the display region AA.

Referring back to FIG. 1, the data driving portion 220 can receive the image data Do and the data control signal DCS from the timing control portion 240, and in response to the data control signal DCS, the data driving portion 220 can convert the image data Do into analog image data i.e., data voltages Vdata, and outputs them to the respective data lines DL.

The power supply portion 230 can generate DC power required for driving the pixel array and the driving circuit portion of the display panel 100 using, for example, a DC-DC converter. The DC-DC converter can include a charge pump, a regulator, a buck converter, a boost converter, etc.

The power supply portion 230 can receive, for example, a power voltage Vcc that is a driving voltage for driving the light emitting display apparatus 10 from the host system, and generate the DC voltages such as the gate low voltages VGL and VEL, the gate high voltages VGH and VEH, the high-potential driving voltage EVDD, the low-potential driving voltage EVSS, the reference voltage Vref, and the reset voltage Var. The gate low voltages VGL and VEL and the gate high voltages VGH and VEH can be supplied to the gate driving portion 210. The high-potential driving voltage EVDD, the low-potential driving voltage EVSS, the reference voltage Vref, and the reset voltage Var can be supplied in common to the pixels P in the display panel 100.

Moreover, the power supply portion 230 can generate, for example, driving voltages (or core voltages) (Vc: Vc1 and Vc2) that drives the timing control portion 240. In addition, the power supply portion 230 can generate, for example, driving currents (or core currents) (Ic: Ic1 and Ic2) that drives the timing control portion 240.

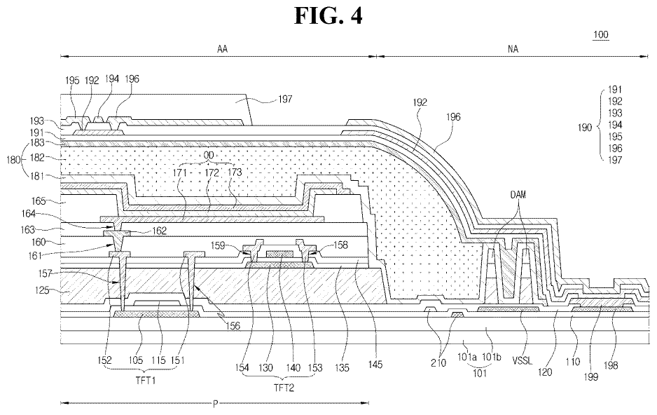

Hereinafter, an example of a cross-sectional structure of the display panel 100 of this embodiment is described with further reference to FIG. 4. FIG. 4 is a cross-sectional view schematically illustrating an example of a cross-sectional structure of a display panel according to an embodiment of the present disclosure.

In FIG. 4, for convenience of explanation, two thin film transistors TFT1 and TFT2 are illustrated in the pixel P within the display region AA. Here, the thin film transistor TFT1 positioned relatively lower and closer to the substrate 101 is referred to as a first thin film transistor TFT1, which can be a polycrystalline silicon thin film transistor. The thin film transistor TFT2 positioned relatively upper and farther from the substrate 101 is referred to as a second thin film transistor TFT2, which can be an oxide thin film transistor.

The first thin film transistor TFT1 can be a fifth transistor (T5 of FIG. 2), but not limited thereto. In addition, the second thin film transistor TFT2 can be a driving transistor (DT of FIG. 2), but not limited thereto.

The substrate 101 can be configured as, for example, a thin glass substrate (or glass film) or a plastic substrate (or plastic film) so as to implement flexible characteristics of the display panel 100.

Here, in a case where the substrate 101 is configured as a glass substrate, for example, the substrate 101 can have a thickness of approximately 0.2 mm.

In a case where the substrate 101 is configured as a plastic substrate, for example, the substrate 101 can include at least one polyimide layer. In this embodiment, the substrate 101 configured of two polyimide layers, which are a first polyimide layer 101a and a second polyimide layer 101b, is taken as an example. In this case, an inorganic insulating layer can be interposed between the first and second polyimide layers 101a and 101b.

The first thin film transistor TFT1 can include a first semiconductor layer 105 disposed on the substrate 101, a first gate electrode 115 overlapping the first semiconductor layer 105 with a first insulating layer 110 interposed therebetween, and a first source electrode 151 and a first drain electrode 152 located on a fourth insulating layer 145 over the first gate electrode 115. Here, the first semiconductor layer 105 can be formed of polycrystalline silicon, but not limited thereto.

The first semiconductor layer 105 can include a central channel region and source and drain regions on both sides thereof. The first source electrode 151 and the first drain electrode 152 can be connected to the source region and the drain region of the first semiconductor layer 105 through the first and second contact holes 156 and 157 that are formed in the insulating layers 110, 120, 125, 135, and 145 located below the first source electrode 151 and the first drain electrode 152.

A second insulating layer 120 can be formed on the first gate electrode 115 of the first thin film transistor TFT1.

A first interlayered insulating layer 125 can be formed on the second insulating layer 120. The second thin film transistor TFT2 can be formed on the first interlayered insulating layer 125.

The second thin film transistor TFT2 can include a second semiconductor layer 130 on the first interlayered insulating layer 125, a second gate electrode 140 overlapping the second semiconductor layer 130 with a third insulating layer 135 interposed therebetween, and a second source electrode 153 and a second drain electrode 154 located on the fourth insulating layer 145 over the second gate electrode 140. Here, the second semiconductor layer 130 can be formed of an oxide semiconductor, but not limited thereto.

The second semiconductor layer 130 can include a central channel region and source and drain regions on both sides thereof. The second source electrode 153 and the second drain electrode 154 can be connected to the source and drain regions of the second semiconductor layer 130 through third and fourth contact holes 158 and 159 formed in the insulating layers 135 and 145 located below the second source electrode 153 and the second drain electrode 154.

A second interlayered insulating layer (or first planarization layer) 160 can be formed on the second thin film transistor TFT2.

Here, the first, second, third, and fourth insulating layers 110, 120, 135, and 145 can be formed of an inorganic insulating material such as silicon nitride or silicon oxide, but not limited thereto.

In addition, the first and second interlayered insulating layers 125 and 160 can be formed of an organic insulating material such as photo acrylic or benzocyclobutene, but not limited thereto.

A connection electrode 162 can be formed on the second interlayered insulating layer 160. The connection electrode 162 can be connected to the first drain electrode 152 through a contact hole 161 formed in the second interlayered insulating layer 160.

A third interlayered insulating layer (or second planarization layer) 163 can be formed on the connection electrode 162. The third interlayered insulating layer 163 can be formed of an organic insulating material such as photo acrylic or benzocyclobutene, but not limited thereto.

The light emitting diode OD and a bank 165 can be formed on the third interlayered insulating layer 163.

The light emitting diode OD can include an anode electrode (or first electrode) 171, a light emitting layer 172, and a cathode electrode (or second electrode) 173.

The anode electrode 171 can be connected to the connection electrode 162 through the contact hole 164 formed in the third interlayered insulating layer 163.

The bank 165 can be disposed along a boundary of the pixel P and can be formed to cover an edge of the anode electrode 171. The light emitting layer 172 can be formed on the anode electrode 171 exposed through an opening of the bank 165.

The cathode electrode 173 can be formed on the light emitting layer 172 and can be applied with the low-potential driving voltage (EVSS of FIG. 2).

An encapsulation layer 180 can be formed on the cathode electrode 173. The encapsulation layer 180 can include at least one inorganic encapsulation layer and at least one organic encapsulation layer, but not limited thereto. In this disclosure, a structure of the encapsulation layer 180, in which a first encapsulation layer 181, a second encapsulation layer 182, and a third encapsulation layer 183 are sequentially stacked, is described as an example.

The first encapsulation layer 181 can be formed on the substrate 101 on which the cathode electrode 173 is formed. The third encapsulation layer 183 can be formed on the substrate 101 on which the second encapsulation layer 182 is formed, and can be formed to surround an upper surface, a lower surface, and a side surface of the second encapsulation layer 182 together with the first encapsulation layer 181. The first encapsulation layer 181 and the third encapsulation layer 183 can minimize or prevent or reduce external moisture or oxygen from penetrating into the light emitting diode OD. The first encapsulation layer 181 and the third encapsulation layer 183 can be formed of an inorganic insulating material capable of low-temperature deposition, such as silicon nitride, silicon oxide, silicon oxynitride, or aluminum oxide.

The second encapsulation layer 182 can acts as a buffer to relieve stress between layers due to bending of the light emitting display apparatus 10, and can flatten steps between layers. The second encapsulation layer 182 can be formed on the substrate 101 on which the first encapsulation layer 181 is formed, using a non-photosensitive organic insulating material such as acrylic resin, epoxy resin, phenolic resin, polyamide resin, polyimide resin, polyethylene, or silicon oxycarbon (SiOC), or a photosensitive organic insulating material such as photo acrylic, but not limited thereto. When the second encapsulation layer 182 is formed through an inkjet method, a dam DAM can be placed in the non-display region NA to prevent or reduce the second encapsulation layer 182 in liquid form from spreading to an edge of the substrate 101. The dam DAM can be disposed closer to the edge of the substrate 101 than the second encapsulation layer 182. By the dam DAM, the second encapsulation layer 182 can be prevented or reduced from spreading to a pad region, where a conductive pad is disposed, on an outermost edge of the substrate 101.

The dam DAM can be designed to prevent or reduce the spreading of the second encapsulation layer 182, but if the second encapsulation layer 182 is formed to exceed a height of the dam DAM during a process, the second encapsulation layer 182 as an organic layer can be exposed to an outside, so that moisture, etc. can easily penetrate into the light emitting element. To prevent or reduce this case, 10 or more dam DAM can be formed in succession, but not limited thereto.

The dam DAM can be formed simultaneously with the first interlayered insulating layer 125, the second interlayered insulating layer 160, and the third interlayered insulating layer 163. When forming the first interlayered insulating layer 125, a lower layer of the dam DAM can be formed together, and when forming the second and third interlayered insulating layers 160 and 163, an upper layer of the dam DAM can be formed together, so that the dam DAM can be formed in a triple laminated structure. As another example, the dam DAM can be formed with one or two of the first, second, and third interlayered insulating layers 125, 160, and 163.

Accordingly, the dam DAM can be formed of the same material as the first interlayered insulating layer 125, the second interlayered insulating layer 160, and the third interlayered insulating layer 163, but not limited thereto.

The dam DAM can be formed to overlap a low-potential driving voltage line VSSL. For example, the low-potential driving voltage line VSSL can be formed at a lower layer of a region, where the dam DAM is located, in the non-display region NA.

The low-potential driving voltage line VSSL and the gate driving portion 210 configured in the GIP structure can be formed along a periphery of the display panel 100, and the low-potential driving voltage line VSSL can be located outside the gate driving portion 210. In addition, the low-potential driving voltage line VSSL can be connected to the cathode electrode 173 to apply the low-potential driving voltage EVSS. The gate driving portion 210 is simply shown in a planar and cross-sectional manner in the drawings, but can be configured with the same structure as the first thin film transistor TFT1 and/or the second thin film transistor TFT2 of the display region AA.

A touch layer (or touch element layer) 190 can be disposed on the encapsulation layer 180. In the touch layer 190, a touch buffer layer 191 can be positioned between a touch sensor metal including touch electrode connection lines 192 and 194 and touch electrodes 195 and 196, and the cathode electrode 173 of the light emitting diode OD.

The touch buffer layer 191 can block a chemical solution (developer, etchant, etc.) used in a manufacturing process of the touch sensor metal disposed on the touch buffer layer 191 or moisture from the outside from penetrating into the light emitting layer 172 containing an organic material. Accordingly, the touch buffer layer 191 can prevent or reduce damage to the light emitting layer 172 that is vulnerable to the chemical solution or moisture.

According to a mutual-capacitance-based touch sensor structure, the touch electrodes 195 and 196 can be disposed on the touch buffer layer 191, and the touch electrodes 195 and 196 can be arranged to cross each other.

The touch electrode connection lines 192 and 194 can electrically connect the touch electrodes 195 and 196. One of the touch electrode connection lines 192 and 194, and the touch electrodes 195 and 196 can be located at different layers with a touch insulation layer 193 interposed therebetween. In addition, one of the touch electrode connection lines 192 and 194 and the other of the touch electrode connection lines 192 and 194 can be located at different layers with the touch insulation layer 193 interposed therebetween.

The touch electrode connection lines 192 and 194 can be arranged to overlap the bank 165, thereby preventing or reducing decrease in aperture ratio, but not limited thereto.

Meanwhile, a part of the touch electrodes 195 and 196 and a part of the touch electrode connection line 192 can extend along the top and side surfaces of the encapsulation layer 180 and the top and side surfaces of the dam DAM and be electrically connected to a touch driving circuit through a touch pad 198 and 199.

A part of the touch electrodes 195 and 196 and a part of the touch electrode connection line 192 can receive a touch driving signal from the touch driving circuit and transmit it to the touch electrodes 195 and 196, and can transmit a touch sensing signal detected by the touch electrodes 195 and 196 to the touch driving circuit.

In this regard, for example, a driving IC (e.g., data IC, etc.) of the data driving portion 220 including the touch driving circuit can be configured in a COF type and connected to the non-display region NA of the substrate 101 of the display panel 100, and in this case, an end of the touch pad 198 and 199 can be connected to a flexible circuit film on which the driving IC is mounted, so that a signal can be transmitted.

A touch protective layer 197 can be disposed on the touch electrodes 195 and 196. In the drawing, the touch protective layer 197 is shown as being disposed only on the touch electrodes 195 and 196, but not limited thereto, and the touch protective layer 197 can extend before or after the dam DAM to be disposed on the touch electrode connection line 192.

In addition, a color filter can be disposed on the encapsulation layer 180. The color filter can be positioned on the touch layer 190, or between the encapsulation layer 180 and the touch layer 190.

The light emitting display apparatus 10 of this embodiment can perform degradation compensation to compensate for a degradation amount accumulated in the pixel P of the display panel 100 as a driving time elapses. Here, the degradation amount can include, for example, a degradation amount of driving characteristics of the light emitting diode OD of the pixel P and/or a degradation amount of driving characteristics (e.g., threshold voltage and/or mobility) of the driving transistor DT of the pixel P. In addition, the degradation amount can depend on temperature, and for example, the degradation amount can change according to a change in temperature.

When the degradation amount is accumulated, the driving current in the pixel P can be reduced, which can cause poor image quality such as afterimages or luminance fluctuation.

To improve this, in a normal driving to display an image, the timing control portion 240 can calculate periodically (for example, by frame) the degradation amount accumulated in the pixel P and generate degradation data DSD representing the degradation amount. The degradation data DSD generated in this way can be transmitted to the memory 300 and updated.

In addition, in a degradation compensation driving, the timing control portion 240 can read the degradation data DSD stored in the memory 300, generate compensation data (or compensation gain) capable of compensating for the degradation amount, and reflect the compensation data to the corresponding input image data Di to generate the output image data (or compensation image data) Do.

As such, the degradation data DSD for the degradation compensation can be frequently transmitted between the timing control portion 240 and the memory 300, and the transmission of the degradation data DSD can be performed via an SPI communication as a high-speed communication.

In the SPI communication, for example, the data transmission can occur based on a clock signal that synchronizes the communication frequency. The clock signal can be generated using the driving voltage Vc and the driving current Ic which are the driving power that drive the timing control portion 240.

However, in a case of using a normal driving voltage Vc1 (e.g., 3.3 V) and a normal driving current Ic1 (e.g., 12 mV), the clock signal can exhibit an overshoot phenomenon, where a high level increases at a rising edge of the clock signal, and an undershoot phenomenon, where a low level decreases at a falling edge of the clock signal.

In this case, noises of an overshoot peak and an undershoot peak can occur in the clock signal, and an amplitude of the clock signal can increase to a potential difference between the overshoot peak and the undershoot peak, thereby increasing an energy of the SPI communication frequency. As such, when the energy of the SPI communication frequency increases, EMI specifications required for a product to which the light emitting display apparatus 10 is applied may not be met, exceeding the EMI specifications.

However, in this embodiment of the present disclosure, while the degradation data DSD is transmitted between the timing control portion 240 and the memory 300 through the SPI communication, a driving voltage Vc2 lower than the normal driving voltage Vc1 and a driving current Ic2 lower than the normal driving current Ic1 can be applied and used.

By using the driving voltage Vc2 lower than the normal driving voltage Vc1 and the driving current Ic2 lower than the normal driving current Ic1, the overshoot and undershoot of the clock signal can be reduced, thereby reducing the amplitude of the clock signal. Consequently, the energy of the SPI communication frequency can be reduced, thereby meeting the required EMI specifications.

The driving method for reducing the energy of the SPI communication frequency by lowering the driving voltage and the driving current in the SPI communication between the timing control portion 240 and the memory 300 of this embodiment according to the present disclosure can be described in more detail below.

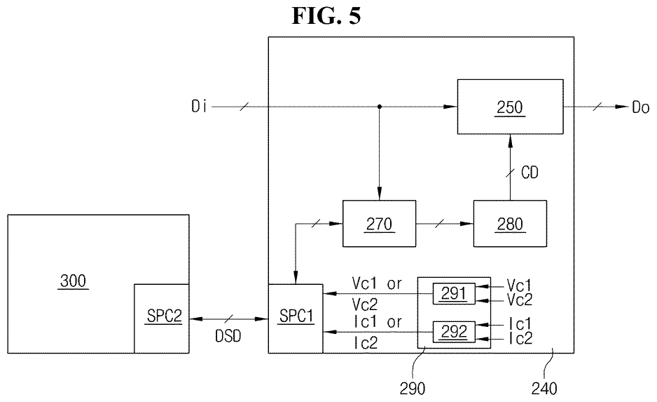

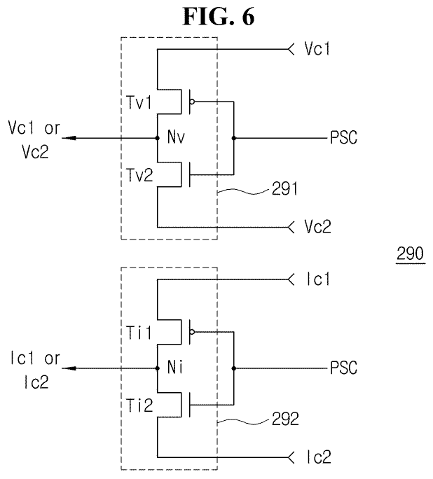

FIG. 5 is a view schematically illustrating configuration of a timing control portion and a memory (e.g., of a display apparatus) according to an embodiment of the present disclosure. FIG. 6 is a view schematically illustrating a driving power selection portion provided in a timing control portion (e.g., of a display apparatus) according to an embodiment of the present disclosure.

Referring to FIGS. 5 and 6 along with FIGS. 1 to 4, the timing control portion 240 of this embodiment can include, for example, a signal processing portion 250, a degradation data calculation portion (or degradation amount calculation portion) 270, a compensation data generation portion 280, a driving power selection portion (or driving power switching portion) 290, and an SPI communication portion SPC1. Here, for convenience of explanation, the SPI communication portion SPC1 of the timing control portion 240 can be referred to as a first SPI communication portion SPC1.

The memory 300 of this embodiment can include, for example, a second SPI communication portion SPC2 that communicates with the first SPI communication portion SPC1 of the timing control portion 240 to transmit and receive signals.

The signal processing portion 250 of the timing control portion 240 can, for example, receive the input image data Di and process the input image data DI to generate and output the output image data Do. Here, the input image data Di can be configured as an array of image data corresponding to the pixels P arranged in the display panel 100. The output image data Do output from the signal processing portion 250 can be transmitted to the data driving portion 220.

Regarding the generation of the output image data Do in the signal processing portion 250, for example, when a degradation compensation function is on, the signal processing portion 250 can receive compensation data CD from the compensation data generation portion 280 and reflect the compensation data CD to the input image data Di to generate the output image data (or compensation image data) Do.

In addition, when the degradation compensation function is off, the signal processing portion 250 can output the input image data Di as the output image data Do without performing the degradation compensation.

The degradation data calculation portion 270 can, for example, receive the input image data Di and, based on the input image data Di, generate the degradation data DSD representing the degradation amount accumulated in the display panel 100.

For example, based on the input image data Di, the degradation data calculation portion 270 can predict the degradation amount accumulated (or generated) in the pixel P up to now to generate the degradation data DSD. For example, the degradation data calculation portion 270 can generate the degradation data DSD on a frame-by-frame basis, and the degradation data DSD of the current frame can be generated by adding the degradation amount induced by the current input image data Di to the degradation data DSD of the immediately previous frame.

As the driving time elapses, the degradation amount can be periodically accumulated in the degradation data DSD, which can be updated.

The degradation of the pixel P can depend on the temperature of the light emitting display apparatus 10. Accordingly, in calculating the degradation data DSD, the degradation data calculation portion 270 can generate the degradation data DSD based on the temperature along with the input image data Di.

Meanwhile, in calculating the degradation data DSD, the degradation amount can be sampled by the pixel P or on by block. Regarding the sampling of the degradation amount by block, each block can be set to correspond to a plurality of pixels P arranged in adjacent rows and columns, and the degradation amount can be sampled by block to generate the degradation data DSD per block. As such, when the block-based sampling of the degradation amount is performed, a size of the overall degradation data DSD can be reduced, so that there is an advantage of reducing capacity of the memory 300.

The degradation data DSD calculated as described above can be configured, for example, in a form of a map, but not limited thereto.

The degradation data DSD calculated by the degradation data calculation portion 270 can be transmitted to the memory 300. The memory 300 can be configured, for example, as a flash memory, but not limited thereto.

The memory 300 can receive the degradation data DSD transmitted from the degradation data calculation portion 270, and update and store it. For example, when the memory 300 receives the current degradation data DSD, it can update the immediately previously stored degradation data DSD. As such, the memory 300 can update and store the degradation amount up to the present.

The degradation data calculation portion 270 can receive (or load) the degradation data DSD stored in the memory 300, and, based on this, calculate the accumulated degradation data DSD accumulated up to now. For example, the degradation data calculation portion 270 can load the immediately previous degradation data DSD stored in the memory 300 and, based on this, accumulate a degradation amount additionally induced by the current input image data Di input currently thereto.

As such, the degradation data calculation portion 270 and the memory 300 can transmit and receive the degradation data DSD between each other, and calculate and store the degradation amount accumulated up to now.

In the degradation compensation driving, the compensation data generation portion 280 can calculate and output the compensation data CD that mitigates the degradation amount accumulated in each pixel P. For example, when power is applied to the light emitting display apparatus 10, the degradation compensation driving can be performed, but not limited thereto.

The compensation data generation portion 280 can receive and analyze the degradation data DSD stored in the memory 300 to generate the compensation data CD for each pixel P. Here, the degradation data DSD stored in the memory 300 can be transmitted to the compensation data generation portion 280 via the degradation data calculation portion 270, or can be directly transmitted from the memory 300 to the compensation data generation portion 280.

For example, the compensation data generation portion 280 can include a lookup table, and when the degradation data DSD is input, the lookup table can be referenced to generate the compensation data CD per pixel P.

Here, the compensation data generation portion 280 can, for example, configure the compensation data CD in a form of a map, but not limited thereto.

The compensation data CD for each pixel P generated by the compensation data generation portion 280 can be transmitted to the signal processing portion 250.

When the compensation data CD is input, the signal processing portion 250 can apply the compensation data CD to the input image data Di per pixel P to generate the compensation image data Do that compensates for the degradation. The compensation image data Do can be provided as the output image data Do to the data driving portion 220.

In this case, the data driving portion 220 can receive the output image data Do, generate corresponding analog signal i.e., the data voltage Vdata, and output it to the data line DL. The data voltage Vdata can be applied to the corresponding pixel P through the data line DL.

Therefore, the degradation occurring in the pixel P of the display panel 100 can be alleviated by the data voltage Vdata that compensates for the degradation.

As mentioned above, the degradation data DSD can be transmitted and received between the timing control portion 240 and the memory 300, and this signal transmission can be performed using the SPI communication.

To perform the SPI communication, the timing control portion 240 can be equipped with the first SPI communication portion SPC1, which can serve as a master module for the SPI communication, and the memory 300 can be equipped with the second SPI communication portion SPC2 which can serve as a slave module for the SPI communication.

The signal transmission between the first and second SPI communication portions SPC1 and SPC2 can be performed, for example, in synchronization with a clock signal that sets the SPI communication frequency.

To perform the SPI communication, the driving voltage Vc and the driving current Ic can be input as the driving power to the first SPI communication portion SPC1 provided in the timing control portion 240.

Using the driving voltage Vc and the driving current Ic, SPI communication signals for performing the SPI communication can be generated. For example, a clock signal implementing the SPI communication and a signal of the degradation data DSD can be generated.

Meanwhile, in this embodiment, when a communication state between the first and second SPI communication portions SPC1 and SPC2 is turned on and a transmission operation of the signal of the degradation data DSD is performed, a relatively low driving power can be provided to the first SPI communication portion SPC1. Furthermore, when the communication state between the first and second SPI communication portions SPC1 and SPC2 is turned off and the transmission operation of the signal of the degradation data DSD is not performed, a normal driving power can be provided.

As such, depending on whether the SPI communication is turned on or off, the driving power that generates the signals used for the SPI communication can be selectively adjusted (controlled or varied). The adjustment of the driving power can be implemented through the driving power selection portion 290.

In this regard, referring to FIG. 6, the driving power selection portion 290 can include a voltage selection portion (or a first selection portion or a first switching portion) 291 that selects and outputs the driving voltage Vc, and a current selection portion (or a second selection portion or a second switching portion) 292 that selects and outputs the driving current Ic.

The voltage selection portion 291 can, for example, receive the first driving voltage Vc1 which is the normal driving voltage Vc1, and the second driving voltage Vc2 which is the voltage lower than the first driving voltage Vc1, and can select and output one of the first and second driving voltages Vc1 and Vc2.

To this end, the voltage selection portion 291 can include, for example, a first voltage switch Tv1 that receives the first driving voltage Vc1, and a second voltage switch Tv2 that receives the second driving voltage Vc2. Each of the first and second voltage switches Tv1 and Tv2 can be formed as a transistor, and one of the first and second voltage switches Tv1 and Tv2 can be formed as an N-type transistor, and the other of the first and second voltage switches Tv1 and Tv2 can be formed as a P-type transistor. In this embodiment, a case in which the first voltage switch Tv1 is formed as a P-type transistor and the second voltage switch Tv2 is formed as an N-type transistor is taken as an example.

The first and second voltage switches Tv1 and Tv2 configured in this manner can be connected in series with each other with a voltage output terminal Nv interposed therebetween, and the first and second voltage switches Tv1 and Tv2 can receive the same control signal, for example, a selection signal PSC at their control terminals i.e., their gate electrodes.

In this case, for example, when the selection signal PSC is at a high-level state, the second voltage switch Tv2 can be turned on and the first voltage switch Tv1 can be turned off, so that the second driving voltage Vc2 can be output through the second voltage switch Tv2. In addition, when the selection signal PSC is at a low-level state, the first voltage switch Tv1 can be turned on and the second voltage switch Tv2 can be turned off, so that the first driving voltage Vc1 can be output through the first voltage switch Tv1.

As such, the voltage selection portion 291 can selectively output the first and second driving voltages Vc1 and Vc2 by having the turn-on/turn-off states of the first and second voltage switches Tv1 and Tv2 reversed according to the selection signal PSC.

The current selection portion 292 can, for example, receive the first driving current Ic1 which is the normal driving current Ic1, and the second driving current Ic2 which is the lower current than the first driving current Ic1, and select and output one of the first and second driving currents Ic1 and Ic2.

To this end, the current selection portion 292 can include, for example, a first current switch Ti1 that receives the first driving current Ic1, and a second current switch Ti2 that receives the second driving current Ic2. Each of the first and second current switches Ti1 and Ti2 can be formed as a transistor, and one of the first and second current switches Ti1 and Ti2 can be formed as an N-type transistor and the other of the first and second current switches Ti1 and Ti2 can be formed as a P-type transistor. In this embodiment, a case in which the first current switch Ti1 is formed as a P-type transistor and the second current switch Ti2 is formed as an N-type transistor is taken as an example.

The first and second current switches Ti1 and Ti2 configured in this manner can be connected in series with each other with a current output terminal Ni interposed therebetween, and the first and second current switches Ti1 and Ti2 can receive the same control signal, for example, the selection signal PSC at their control terminals i.e., their gate electrodes.

In this case, for example, when the selection signal PSC is at a high-level state, the second current switch Ti2 can be turned on and the first current switch Ti1 can be turned off, so that the second driving current Ic2 can be output through the second current switch Ti2. In addition, when the selection signal PSC is at a low-level state, the first current switch Ti1 can be turned on and the second current switch Ti2 can be turned off, so that the first driving current Ic1 can be output through the first current switch Ti1.

As such, the current selection portion 292 can selectively output the first and second driving currents Ic1 and Ic2 by having the turn-on/turn-off states of the first and second current switches Ti1 and Ti2 reversed according to the selection signal PSC.

Meanwhile, in this embodiment, a case in which the voltage selection portion 291 and the current selection portion 292 perform the switching operations by receiving the same selection signal PSC is taken as an example. Alternatively, the voltage selection portion 291 and the current selection portion 292 can be configured to receive individual selection signals PSC.

As described above, the driving power selection portion 290 configured with the voltage selection portion 291 and the current selection portion 292 can select the driving power that generates signals used for the SPI communication according to the on/off SPI communication.

In this regard, for example, when the SPI communication is turned on to transmit the degradation data DSD between the timing control portion 240 and the memory 300, the driving power selection portion 290 can operate to output a relatively low driving power. In this regard, the selection signal PSC can have a high level, and accordingly, the voltage selection portion 291 can turn on the second voltage switch Tv2 to select and output the second driving voltage Vc2 which is a low voltage, and the current selection portion 292 can turn on the second current switch Ti2 to select and output the second driving current Ic2 which is a low current.

In addition, when the degradation data DSD is not transmitted between the timing control portion 240 and the memory 300 and thus the SPI communication is turned off, the driving power selection portion 290 can operate to output a relatively high driving power. In this regard, the selection signal PSC can have a low level, and accordingly, the voltage selection portion 291 can turn on the first voltage switch Tv1 to select and output the first driving voltage Vc1 which is a normal voltage, and the current selection portion 292 can turn on the first current switch Ti1 to select and output the first driving current Ic1 which is a normal current.

As such, when the SPI communication is turned on and thus the operation to transmit the degradation data DSD is performed, the driving power lower than the normal driving power can be generated and the SPI communication signal can be generated using the lower driving power.

As such, in the case in which the SPI communication is turned on and the operation to transmit the degradation data DSD between the timing control portion 240 and the memory 300 is performed, when the relatively low driving power is selected and the SPI communication signal is generated based on the relatively low driving power, the amplitude of the SPI communication signal can be reduced compared to the SPI communication signal generated based on the normal driving power.

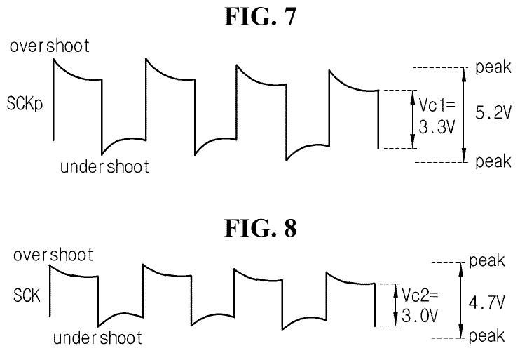

This can be described with further reference to FIGS. 7 and 8. FIG. 7 is a view schematically illustrating an example of a waveform of a clock signal generated using a normal driving power in an SPI communication according to a comparative example. FIG. 8 is a view schematically illustrating an example of a waveform of a clock signal generated using a low driving power in an SPI communication according to an embodiment of the present disclosure.

Regarding the comparative example of FIG. 7, when the first driving voltage Vc1 as the normal driving voltage Vc1, for example, 3.3V, and the first driving current Ic1 as the normal driving current Ic1, for example, 12 mV are used, a clock signal SCKp can have an overshoot phenomenon in which a potential at a rising edge becomes higher than a normal high level (i.e., 3.3V), and an undershoot phenomenon in which a potential at the falling edge becomes lower than a normal low level (i.e., 0V).

In this case, noises of overshoot peak and undershoot peak occur in the clock signal SCKp, and the amplitude of the clock signal SCKp significantly increases to a potential difference between the overshoot peak and undershoot peak, for example, approximately 5.2V, thereby increasing the energy of the SPI communication frequency.

As such, the energy of the SPI communication frequency increases, and thus the EMI specifications required for a product to which the light emitting display apparatus 10 is applied are not met, exceeding the EMI specifications. For example, in a case where the light emitting display apparatus 10 is applied to a vehicle, the SPI communication noise can interfere with normal operation of other electronic devices installed in the vehicle.

However, regarding the embodiment of FIG. 8, when the second driving voltage Vc2 lower than the normal driving voltage Vc1, for example, 3.0V, and the second driving current Ic2 lower than the normal driving current Ic1, for example, 8 mV are sued, a clock signal SCK can have an overshoot phenomenon in which a potential at a rising edge becomes higher than a high level (i.e., 3.0V) of the second driving voltage Vc2, and an undershoot phenomenon in which a potential at a falling edge becomes lower than a normal low level (i.e., 0V).

In this case, compared to the clock signal SCKp of the comparative example, the overshoot and the undershoot in the clock signal SCK of this embodiment can be reduced, so that a potential difference between the overshoot peak and the undershoot peak, which is a amplitude of the clock signal (SCK), can be reduced to, for example, approximately 4.7V, thereby reducing the energy of the SPI communication frequency.

As such, in the case where the SPI communication is turned on and the signal transmission operation is performed, when the low driving voltage is selected to generate the SPI communication signal, even if the overshoot and the undershoot occur in the SPI communication signal, the amplitude of the clock signal SCK, which is the potential difference between the overshoot peak and the undershoot peak, can be reduced compared to when using the normal driving voltage.

Accordingly, the energy of the SPI communication frequency can be reduced, allowing the required EMI specifications to be met. In this case, for example, a phenomenon in which the SPI communication noise interfering with the normal operation of other electronic devices installed in the vehicle can be alleviated.

Meanwhile, the second driving voltage Vc2 selected in the on state of the SPI communication can be, for example, approximately 90% to 60% of the first driving voltage Vc1, more preferably approximately 80% to 70% of the first driving voltage Vc1, but not limited thereto.

In addition, the second driving current Ic2 selected in the on state of the SPI communication can be, for example, approximately 90% to 60% of the first driving current Ic1, more preferably approximately 80% to 70% of the first driving current Ic1, but not limited thereto.

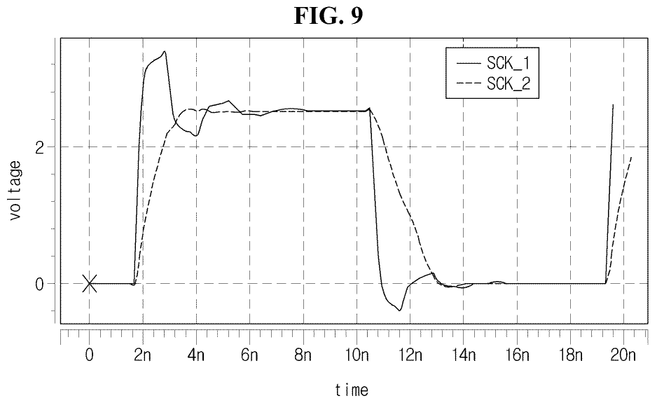

FIG. 9 is a view illustrating simulation results for clock signals generated using a low driving power in an SPI communication according to an embodiment of the present disclosure.

In FIG. 9, in the SPI communication, a clock signal SCK_1 generated when a driving voltage is 2.5V and a driving current is 12 mA as a first example of this embodiment, and a clock signal SCK_2 generated when a driving voltage is 2.5V and a driving current is 8 mA as a second example of this embodiment are illustrated.

In the first example, it can be seen that overshoot and undershoot occur to a certain degree in the clock signal SCK_1.

In the second example, it can be seen that substantially no overshoot or undershoot occurs in the clock signal SCK_2.

As such, by lowering the driving voltage and the driving current, the overshoot and undershoot phenomena can be reduced or prevented, resulting in an effective reduction in the energy of the SPI communication frequency.

In the above-described embodiment of the the present disclosure, the case where both the driving voltage and driving current are lowered in order to lower the driving power used for the SPI communication is taken as an example. Alternatively, it can be configured to use a lower driving power by lowering either the driving voltage or the driving current. Consequently, in this embodiment, in implementing the SPI communication, the driving power can be reduced by reducing the driving voltage and/or the driving current.

As described above, in the embodiments of the present disclosure, when the degradation data is transmitted between the timing control portion and the memory through the SPI communication, the driving power lower than the normal driving power can be selected and used to generate the SPI communication signal.

Accordingly, in the embodiments of the present disclosure, the overshoot and the undershoot of the SPI communication signal can be reduced or minimized, thereby reducing the amplitude of the clock signal. Therefore, the energy of the SPI communication frequency can be reduced or minimized, thereby meeting the required EMI specifications.

Furthermore, in the embodiments of the present disclosure, the SPI communication can be performed using the driving power lower than the normal driving power, so that power consumption of the light emitting display apparatus can be reduced or minimized, enabling low-power operation.

It will be apparent to those skilled in the art that various modifications and variation can be made in the present disclosure without departing from the technical idea or scope of the disclosure. Thus, it is intended that the present disclosure cover the modifications and variations of this disclosure provided they come within the scope of the appended claims and their equivalents.

What is claimed is:

1. A light emitting display apparatus, comprising:
a display panel including pixels arranged therein, each of the pixels including a light emitting diode;
a timing control portion including a degradation data calculation portion configured to calculate degradation data representing a degradation amount of a pixel among the pixels based on input image data, and a first serial peripheral interface (SPI) communication portion configured to transmit and receive the degradation data through an SPI communication;
a memory including a second SPI communication portion configured to perform the SPI communication with the first SPI communication portion, the memory being configured to store the degradation data; and
a driving power selection portion configured to selectively provide a first driving power and a second driving power lower than the first driving power to the first SPI communication portion,
wherein when the SPI communication is on, the second driving power is provided to the first SPI communication portion.

2. The light emitting display apparatus of claim 1, wherein when the SPI communication is off, the first driving power is provided to the first SPI communication portion.

3. The light emitting display apparatus of claim 1, wherein the driving power selection portion includes:
a voltage selection portion configured to select and output one of a first driving voltage and a second driving voltage lower than the first driving voltage; and
a current selection portion configured to select and output one of a first driving current and a second driving current lower than the first driving current.

4. The light emitting display apparatus of claim 3, wherein the voltage selection portion includes a first voltage switch to which the first driving voltage is applied, and a second voltage switch to which the second driving voltage is applied, and
wherein the first voltage switch and the second voltage switch have opposite states with each other among turn-on and turn-off states according to a selection signal, and select and output one of the first driving voltage and the second driving voltage.

5. The light emitting display apparatus of claim 3, wherein the current selection portion includes a first current switch to which the first driving current is applied, and a second current switch to which the second driving current is applied, and
wherein the first current switch and the second current switch have opposite states with each other among turn-on and turn-off states according to a selection signal, and select and output one of the first driving current and the second driving current.

6. The light emitting display apparatus of claim 3, wherein when the SPI communication is on, the second driving voltage and the second driving current are selected and provided to the first SPI communication portion.

7. The light emitting display apparatus of claim 3, wherein the second driving voltage is 90% to 60% of the first driving voltage, and the second driving current is 90% to 60% of the first driving current.

8. The light emitting display apparatus of claim 3, wherein the second driving voltage is approximately 80% to 70% of the first driving voltage, and the second driving current is approximately 80% to 70% of the first driving current.

9. The light emitting display apparatus of claim 1, wherein the timing control portion includes:
a compensation data generation portion configured to generate compensation data based on the degradation data stored in the memory in a degradation compensation; and
a signal processing portion configured to receive the input image data and apply the compensation data to the input image data to generate output image data.

10. The light emitting display apparatus of claim 1, wherein the degradation data calculation portion is configured to generate the degradation data on a frame-by-frame basis, and the degradation data of a current frame is generated by adding the degradation amount induced by a current input image data to the degradation data of a previous frame.

11. A light emitting display apparatus, comprising:
a display panel including pixels arranged therein, each of the pixel including a light emitting diode;
a timing control portion including a degradation data calculation portion configured to calculate degradation data of a pixel among the pixels based on input image data;
a memory configured to transmit and receive the degradation data through serial peripheral interface (SPI) communication with the timing control portion; and
a driving power selection portion configured to adjust a driving power of the timing control portion,
wherein the driving power selection portion is configured to adjust the driving power to be lowered when the SPI communication is on.

12. The light emitting display apparatus of claim 11, wherein the driving power selection portion is configured to adjust the driving power to be lower when the SPI communication is on than when the SPI communication is off.

13. The light emitting display apparatus of claim 11, wherein the driving power selection portion includes:
a voltage selection portion configured to select and output one of a first driving voltage and a second driving voltage lower than the first driving voltage; and
a current selection portion configured to select and output one of a first driving current and a second driving current lower than the first driving current.

14. The light emitting display apparatus of claim 13, wherein the voltage selection portion includes a first voltage switch to which the first driving voltage is applied, and a second voltage switch to which the second driving voltage is applied, and
wherein the first voltage switch and the second voltage switch have opposite states with each other among turn-on and turn-off states according to a selection signal, and select and output one of the first driving voltage and the second driving voltage.

15. The light emitting display apparatus of claim 13, wherein the current selection portion includes a first current switch to which the first driving current is applied, and a second current switch to which the second driving current is applied, and
wherein the first current switch and the second current switch have opposite states with each other among turn-on and turn-off states according to a selection signal, and select and output one of the first driving current and the second driving current.

16. The light emitting display apparatus of claim 13, wherein when the SPI communication is on, the second driving voltage and the second driving current are selected.

17. The light emitting display apparatus of claim 13, wherein the second driving voltage is 90% to 60% of the first driving voltage, and the second driving current is 90% to 60% of the first driving current.

18. The light emitting display apparatus of claim 13, wherein the second driving voltage is approximately 80% to 70% of the first driving voltage, and the second driving current is approximately 80% to 70% of the first driving current.

19. The light emitting display apparatus of claim 11, wherein the degradation data calculation portion is configured to generate the degradation data on a frame-by-frame basis, and the degradation data of a current frame is generated by adding a degradation amount induced by a current input image data to the degradation data of a previous frame.
